(19) United States
(12) Patent Application Publication
(10) Pub. No.: US 2008/0203718 A1
(43) Pub. Date: Aug. 28, 2008

(54) Vehicle with Components Arranged Relative to Chassis Frame

(75) Inventor: Bruce P. Hollenbeck, Orefield, PA (US)

Correspondence Address: WRB-IP LLP, 1217 KING STREET, ALEXANDRIA, VA, 22314, US

(73) Assignee: MACK TRUCKS, INC., Allentown, PA (US)

(21) Appl. No.: 11/917,222

(22) PCT Filed: Jun. 22, 2005
(86) PCT No.: PCT/US05/22048

§ 371 Date: Dec. 12, 2007

(51) Int. Cl. B62D 21/02; B62D 21/18

(52) U.S. Cl. 280/781; 180/312

(57) ABSTRACT

A vehicle includes a chassis frame including at least one substantially straight rail extending in a longitudinal direction of the vehicle, and a cab having a floor at least partially disposed vertically below the at least one rail.

### BACKGROUND AND SUMMARY

The present invention relates generally to vehicles with chassis frames and, more particularly, to such vehicles with components such as vehicle cabs and seats arranged relative to a chassis frame of the vehicle.

Trucks are typically divided into the following categories: heavy duty trucks (above 33,000 lbs (14,968 kg) Gross Vehicle Weight GVW); medium duty trucks (19,500 lbs (8845 kg) to 33,000 lbs (14,968 kg)); or light duty trucks (10,000 lbs (4536 kg) to 19,500 lbs (8845 kg)). Heavy duty trucks are typically divided into the following categories: long haul highway-type trucks with sleeper cabs; distribution highway-type trucks without sleepers; and vocational trucks, which are specialized trucks with bodies mounted on the vehicle frames, such as concrete mixers, dump bodies, block trucks, refuse collection bodies, etc. Medium duty trucks are often distribution vehicles for metropolitan goods transport. Light duty trucks are often distribution vehicles for local and city goods delivery.

Typical uses for heavy duty distribution vehicles are for delivering goods from warehouses to, for example, retail establishments, supermarkets, restaurants, etc. These vehicles cycle throughout the day, with drivers typically making between five and thirty stops. Drivers value easy exit/entry from the cabs of such vehicles. In heavy duty distribution vehicles, exit and entry is typically facilitated by keeping the cab height low, and by providing steps to the cab. However, a characteristic feature of heavy duty trucks is a cab mounted on a separate frame capable of carrying the intended load. The rails of the frame are typically quite large. Accordingly, a limiting factor to keeping cab height low is that the cab 229 is placed above the chassis frame 223 as seen, for example, in FIGS. 2A and 2B. Also, seats 237 and 239 are often disposed on top of the frame rails 225 and 227, as seen in FIG. 2C, thus also limiting the lowest position of the cab 229.

Light duty distribution vehicles typically make fifty to one hundred stops per day. A common architecture for such vehicles is shown in FIG. 3. In some of these vehicles, exit from and entry to the vehicle is facilitated by lowering the cab floor 331 below the rails 325 of the chassis frame to provide a “step in/step out” arrangement to minimize driver fatigue and improve productivity. The floor 331 and the vehicle seat 337 in the embodiment illustrated in FIG. 3 are disposed between rails of the frame.

Light duty distribution vehicles, however, are limited in capacity due to their size and weight restrictions. Therefore, their productivity is limited, as drivers often must return to a warehouse multiple times during the day to be reloaded. As a result, it has become common to use larger, heavy duty vehicles for deliveries to smaller establishments so that the driver will have sufficient cargo for deliveries for an entire day. Because the driver will be making more numerous stops during the day, the frequent exits from and entries to the high cab of the heavy duty distribution vehicle can become quite fatiguing.

It is desirable to provide a vehicle that permits carrying heavy loads while also facilitating exit from and entry to the vehicle.

In accordance with an aspect of the present invention, a heavy duty truck, comprises a heavy duty truck chassis frame comprising at least one substantially straight rail extending in a longitudinal direction of the truck, and a truck cab having a floor at least partially disposed vertically below the at least one rail.

In accordance with an aspect of the present invention, a vehicle comprises a vehicle chassis frame comprising at least one rail extending in a longitudinal direction of the vehicle, the at least one rail comprising a lateral dimension, and a seat disposed entirely outside of the lateral dimension.

In accordance with an aspect of the present invention, a vehicle comprises a vehicle chassis frame comprising at least one rail extending in a longitudinal direction of the vehicle and comprising a lateral dimension. The vehicle also comprises a vehicle cab having a floor, at least a portion of the floor being disposed vertically below the at least one rail and laterally outside of the lateral dimension.

### BRIEF DESCRIPTION OF THE DRAWINGS

The features and advantages of the present invention are well understood by reading the following detailed description in conjunction with the drawings in which like numerals indicate similar elements and in which:

FIGS. 1A-1C are schematic side, top, and front views, respectively, of a truck according to an embodiment of the present invention;

FIGS. 2A-2C are schematic side, top, and front views, respectively, of a truck according to the prior art; and

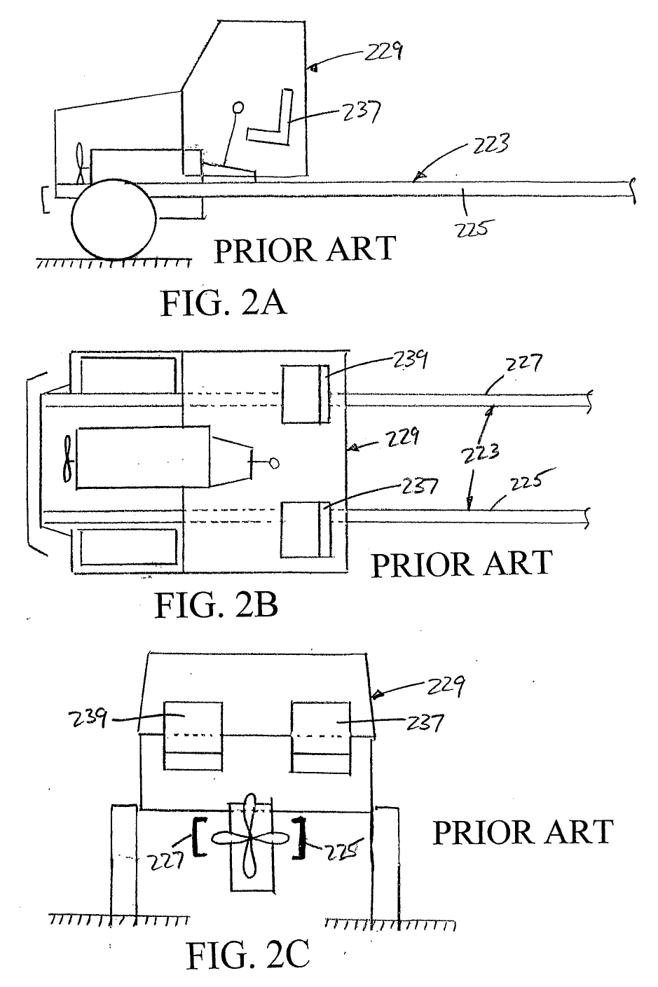

FIG. 3 is a schematic side view of a truck according to the prior art.

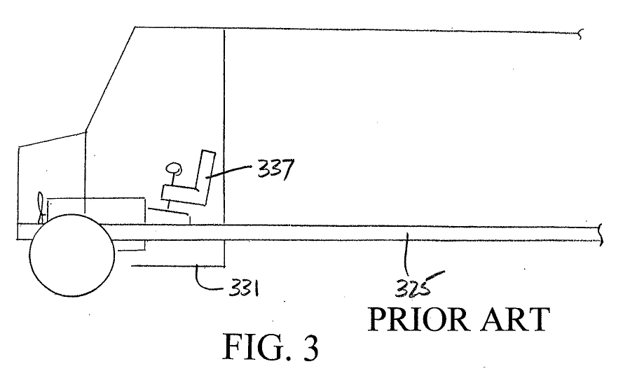

### DETAILED DESCRIPTION

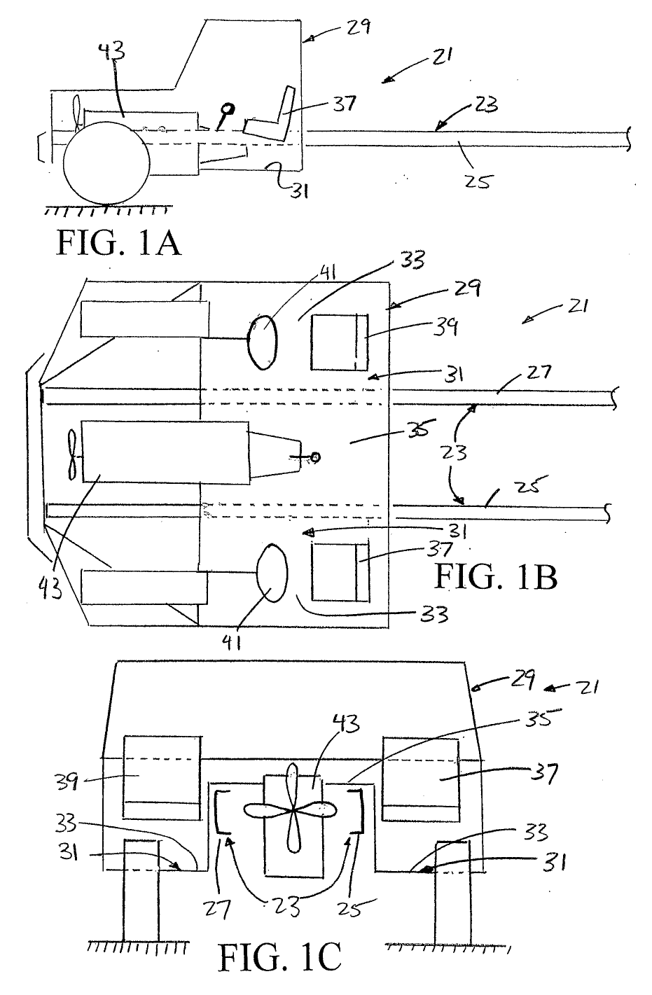

FIGS. 1A-1C schematically show a truck 21 according to an embodiment of the present invention. The truck 21 in this embodiment is a heavy duty truck (above 33,000 lbs (14,968 kg) Gross Vehicle Weight GVW). The embodiment of FIGS. 1A-1C is illustrative and not limiting. The present invention can be used in connection with medium duty trucks (19,500 lbs (8845 kg) to 33,000 lbs (14,968 kg)) or light duty trucks (10,000 lbs (4536 kg) to 19,500 lbs (8845 kg)). Except where otherwise noted, the following description will be applicable to all vehicle and truck types, not just heavy duty trucks. The following discussion will refer to “trucks”, however, it will be appreciated that the present invention is also applicable and relates to vehicles that are not ordinarily characterized as trucks. Two-wheeled vehicles such as motorcycles are not, however, considered to be part of the present invention.

The truck 21 comprises a truck chassis frame 23. In the case of the heavy duty truck 21, the truck chassis frame 23 is a heavy duty truck chassis frame comprising at least one, typically at least two, rails 25 and 27 extending in a longitudinal direction of the truck. To simplify discussion, the embodiment with two rails 25 and 27 will be discussed herein, except as otherwise noted. As is common in heavy duty trucks, the rails 25 and 27 are substantially straight, at least in part because, for a heavy duty truck, the rails are typically of sufficiently great size to make bending the rails rather difficult. However, the rails 25 and 27 are not necessarily substantially straight and, in appropriate circumstances, may be bent, twisted, or may otherwise deviate from being substantially straight, particularly in trucks that are not heavy duty trucks and do not require rails as large as those typically used in heavy duty trucks.

The truck 21 comprises a truck cab 29 having a floor 31. The use of the term “cab” is not intended to limit the description to truck cabs, and it will be appreciated that the term “cab” is intended to refer generally to vehicle compartments in which, ordinarily, a vehicle driver is seated. The term “floor” is intended to describe that surface forming at least part of the bottom surface of a cab, exclusive of steps leading to the floor surface. The floor 31 is at least partially disposed vertically below the rails 25 and 27. At least a portion 33 of the floor disposed laterally outward of a footprint, or lateral dimension, of the rails 25 and 27 is disposed vertically below the rails. A portion 35 of the cab floor 31 between the rails 25 and 27 can also be disposed vertically below the rails, however, the region between the rails may have no floor, or may be filled with equipment that has a different bottom than the portion 33 of the floor.

Ordinarily, the floor 31 will comprise two portions 33 disposed laterally outward of the lateral dimension of the rails 25 and 27. One or, more typically, both portions 33 will be disposed laterally outward of the lateral dimension of the rails 25 and 27. Typically, portions 33 on opposite sides of the rails 25 and 27 will be disposed at the same height, however, if desired, the cab floor portions on opposite sides of the rails can be disposed at different heights. For example, the floor portion 33 on the driver's side might be higher than the floor portion on the passenger side to facilitate providing the driver with a better view, while the passenger side floor portion can be lower to facilitate entry and exit from the cab.

One or more seats, such as a driver's seat 37 and a passenger's seat 39, are disposed entirely laterally outward of the rails 25 and 27. The seats 37 and 39 are disposed in the portion or portions 33 laterally outside of or on opposite sides of the rails 25 and 27. Additional seats (not shown) may be provided between the rails 25 and 27. The embodiment of the truck 21 illustrated in FIGS. 1A-1C shows a driver's seat 37 on the left-hand side of the truck. It will be appreciated that the driver's seat (as well as the controls 41 such as the steering wheel, accelerator, brake, etc.) can instead be disposed on the right-hand side of the truck. Further, controls 41 can be disposed on both the right-hand and the left-hand side of the truck such that the seats on either side of the truck can be considered to be “driver's” seats.

The height of the seats 37 and 39 is ordinarily a function of the height of the cab floor 31 to which the seats are attached. Thus, if portions 33 on opposite sides of the rails 25 and 27 are disposed at different heights, seat portions of identical seats will also be disposed at different heights. Of course, if different seats are used, the seat portions can be disposed at the same heights, such as by using shorter base portion beneath the seat portions.

In the truck 21, at least a portion of an engine 43—in the illustrated embodiment, the entire engine—is disposed forward of the truck cab 29. In other embodiments (not shown), the engine may be disposed behind the truck cab 29. In other embodiments (not shown), the engine 43 may overlap a footprint of the truck cab 29, such as by having at least some portion disposed forward of or at least some portion disposed behind the truck cab. The engine 41 will ordinarily be substantially disposed between the rails 25 and 27 as opposed to extending laterally substantially outside the footprint of the rails. The engine 43 can be positioned vertically relative to the rails 25 and 27 in any suitable position. However, because it will ordinarily be desirable to keep the driver's seat 37 low, it will ordinarily also be desirable to keep the engine as low as possible relative to the rails 25 and 27 so that the driver can more easily see over the engine, particularly when the engine 43 is forward of the truck cab 29.

In another aspect of the present invention shown in FIGS. 1A-1C, the truck 21 comprises the truck chassis frame 23 comprising at least one rail, ordinarily at least two rails 25 and 27, extending in the longitudinal direction of the truck. The rails 25 and 27 may be substantially straight or may deviate from being substantially straight. The rails 25 and 27 comprise a lateral dimension. At least one seat, such as the driver's seat 37 or the passenger's seat 39, is disposed entirely outside of the lateral dimension. A second seat, ordinarily the other one of the driver's seat 37 or the passenger's seat 39, can be disposed entirely outside of the lateral dimension, as well. Ordinarily, the passenger's seat 39 and the driver's seat 37 are disposed on laterally opposite sides of the lateral dimension defined by the rails 25 and 27.

In yet another aspect of the present invention shown in FIGS. 1A-1C, the truck comprises the truck chassis frame 23 comprising at least one rail, ordinarily at least two rails 25 and 27, extending in the longitudinal direction of the truck and comprising a lateral dimension. The rails 25 and 27 may be substantially straight or may deviate from being substantially straight. The truck also comprises the truck cab 29 including the floor 31. At least a portion of the floor 31 is disposed vertically below the rails 25 and 27 and laterally outside of the lateral dimension. At least a portion of the engine 41 is disposed forward of the truck cab 29.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A heavy duty truck, comprising:
a heavy duty truck chassis frame comprising at least one substantially straight rail extending in a longitudinal direction of the truck; and
a truck cab having a floor at least partially disposed vertically below the at least one rail.

2. The heavy duty truck as set forth in claim 1, further comprising an engine, at least a portion of the engine being disposed forward of the truck cab.

3. The heavy duty truck as set forth in claim 1, wherein the at least one rail comprises a lateral dimension, the truck comprising at least one seat disposed entirely outside of the lateral dimension.

4. The heavy duty truck as set forth in claim 1, wherein the at least one rail comprises a lateral dimension, the truck comprising at least two seats disposed entirely outside of the lateral dimension on laterally opposite sides of the at least one rail.

5. The heavy duty truck as set forth in claim 1, wherein the chassis frame comprises at least two substantially straight rails extending in the longitudinal direction of the truck.

6. The heavy duty truck as set forth in claim 5, wherein the at least two rails comprise a lateral dimension, the truck comprising at least one seat disposed entirely outside of the lateral dimension.

7. The heavy duty truck as set forth in claim 5, wherein the at least two rails comprise a lateral dimension, the truck comprising at least two seats disposed entirely outside of the lateral dimension on laterally opposite sides of the at least two rails.

8. The heavy duty truck as set forth in claim 5, further comprising an engine, at least a portion of the engine being disposed forward of the truck cab.

9. The heavy duty truck as set forth in claim 8, wherein the engine is substantially disposed between the at least two rails.

10. The heavy duty truck as set forth in claim 5, further comprising an engine substantially disposed between the at least two rails.

11. A vehicle, comprising:
a vehicle chassis frame comprising at least one rail extending in a longitudinal direction of the vehicle, the at least one rail comprising a lateral dimension; and
a seat disposed entirely outside of the lateral dimension.

12. The vehicle as set forth in claim 11, comprising a second seat disposed entirely outside of the lateral dimension, the second seat and the first seat being disposed on laterally opposite sides of the lateral dimension.

13. The vehicle as set forth in claim 12, comprising first and second sets of vehicle controls disposed proximate each of the first and second seats, respectively.

14. The vehicle as set forth in claim 11, wherein the chassis frame comprises at least two rails extending in the longitudinal direction of the vehicle.

15. The vehicle as set forth in claim 14, comprising a second seat disposed entirely outside of the lateral dimension, the second seat and the first seat being disposed on laterally opposite sides of the lateral dimension.

16. The vehicle as set forth in claim 14, further comprising an engine substantially disposed between the at least two rails.

17. A vehicle, comprising:
a vehicle chassis frame comprising at least one rail extending in a longitudinal direction of the vehicle and comprising a lateral dimension;
a vehicle cab having a floor, at least a portion of the floor being disposed vertically below the at least one rail and laterally outside of the lateral dimension.

18. The vehicle as set forth in claim 17, comprising at least one seat disposed entirely outside of the lateral dimension.

19. The vehicle as set forth in claim 17, comprising an engine, at least a portion of the engine being disposed forward of the vehicle cab.

20. The vehicle as set forth in claim 17, wherein the chassis frame comprises at least two rails extending in the longitudinal direction of the vehicle, the engine being substantially disposed between the at least two rails.
